(19) United States
(12) Patent Application Publication
(10) Pub. No.: US 2002/0120943 A1
(43) Pub. Date: Aug. 29, 2002

(54) Broadcast receiving apparatus and received program selection method

(75) Inventors: Fumio Seto, Kanagawa-ken (JP); Masayuki Takada, Gunma-ken (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 10/078,467

(22) Filed: Feb. 21, 2002

(30) Foreign Application Priority Data
Feb. 28, 2001 (JP) P2001-055295

(51) Int. Cl. H04N 5/445; H04N 7/16

(52) U.S. Cl. 725/135; 725/139; 725/46

(57) ABSTRACT

Past program-selection history is stored as databases in a storage unit. When selecting a new program, a program that will be requested most at this moment by the user is predicted based on the databases stored in the storage unit, program information acquired by a program information acquisition unit, and current time information and current location information acquired by a time/location information acquisition unit, and the prediction result is used as a program selection index.

### BACKGROUND OF THE INVENTION

1. Field of the Invention

The present invention relates to a broadcast receiving apparatus and a received program selection method for receiving a plurality of programs broadcast by broadcasting stations and for selecting a program from the plurality of programs for presentation to a user.

2. Description of the Related Art

Conventionally, when selecting a program from a plurality of television or radio programs broadcast from broadcasting stations, the user usually switches the channel to select a desired program.

Recent introduction of real digital broadcasting has significantly increased the number of programs a broadcast receiving apparatus can receive. An increase in the number of receivable programs will allow the user to select from a wider range of programs and to select a program best matches user's taste. On the other hand, too many programs, if received by a broadcast receiving apparatus, would make it extremely difficult for the user to select a desired program appropriately and quickly.

To solve this problem, various technologies are proposed for helping the user select programs. For example, Japanese Patent Laid-Open Publication No. Hei 2000-48029 discloses a technology that allows the user to define keyword information indicating his or her taste in advance and, based on this keyword information, searches for programs to be received or to be recorded on a recording medium.

Searching for programs to be received or to be recorded on a recording medium based on user-defined keyword information in this manner enables the user to easily select programs that match user's taste, thus reducing the load of program selection by the user.

### SUMMARY OF THE INVENTION

However, the technology disclosed in Japanese Patent Laid-Open Publication No. Hei 2000-48029 requires the user to define, in advance, keyword information indicating user's taste and therefore forces the user to do a cumbersome task. In particular, program selection precisely reflecting the user's taste would require the user to define various keywords carefully. This is a great nuisance to the user.

In addition, programs requested by the user vary according to the time and the place. Therefore, the programs searched for based only on the user's taste are not always those most requested by the user at a particular time and in a particular place. In particular, for a broadcast receiving apparatus mounted on a vehicle such as a car where the receivable programs can change as the car goes around, there is a need for reflecting information about the time and the place on program selection.

In view of the foregoing, it is an object of the present invention to provide a broadcast receiving apparatus and a received program selection method that appropriately select a program, which will be selected by the user according to the time and the place, without forcing the user to do a cumbersome task.

To solve the above problems, there is provided a broadcast receiving apparatus that receives a plurality of programs broadcast by broadcasting stations and selects any one of the plurality of programs for presentation to a user, the broadcast receiving apparatus comprising: a program information acquisition unit configured to acquire program information on programs broadcast by the broadcasting stations; a time/location information acquisition unit configured to acquire at least one of current time information and current location information; a storage unit configured to store information; and a controller configured to control an operation of the broadcast receiving apparatus, wherein the controller stores, into the storage unit as a database, contents of a program selected in the past and satisfying predetermined conditions and at least one of program selection time information and location information and, at the same time, predicts one of the plurality of received programs that will be requested by the user at this moment, based on the database stored in the storage unit, the program information acquired by the program information acquisition unit, and at least one of the current time information and the current location information acquired by the time/location information acquisition unit, for use as a program selection index.

To solve the above problems, there is provided a broadcast receiving apparatus that receives a plurality of programs broadcast by broadcasting stations and selects any one of the plurality of programs for presentation to a user, the broadcast receiving apparatus comprising: program information acquisition means for acquiring program information on programs broadcast by the broadcasting stations; time/location information acquisition means for acquiring at least one of current time information and current location information; storage means for storing information; and control means for controlling an operation of the broadcast receiving apparatus, wherein the control means stores, into the storage means as a database, contents of a program selected in the past and satisfying predetermined conditions and at least one of program selection time information and location information and, at the same time, predicts one of the plurality of received programs that will be requested by the user at this moment, based on the database stored in the storage means, the program information acquired by the program information acquisition means, and at least one of the current time information and the current location information acquired by the time/location information acquisition means, for use as a program selection index.

To solve the above problems, there is provided a received program selection method, comprising: acquiring program information on programs broadcast by broadcasting stations; acquiring at least one of current time information and current location information; storing, into a storage unit as a database, contents of a program selected in the past and satisfying predetermined conditions and at least one of program selection time information and location information; and predicting one of a plurality of programs, received from broadcasting stations, that will be requested by the user at this moment, based on the database stored in the storage unit, the acquired program information, and at least one of the acquired current time information and the current location information, for use as a program selection index.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing the configuration of an onboard phonographic equipment to which the present invention is applied;

FIG. 2 is a diagram showing an example of a database stored in a storage unit of the onboard phonographic equipment;

FIG. 3 is a diagram showing an example of a database stored in a storage unit of the onboard phonographic equipment;

FIG. 4 is a diagram showing an example of a database stored in a storage unit of the onboard phonographic equipment;

FIG. 5 is a diagram showing the processing operation of the onboard phonographic equipment and is a flowchart showing processing in which program selection information is stored as databases in the storage unit;

FIG. 6 is a diagram showing the processing operation of the onboard phonographic equipment and is a flowchart showing processing in which program selection information is stored as databases in the storage unit;

FIG. 7 is a diagram showing the processing operation of the onboard phonographic equipment and is a flowchart showing processing in which a program is selected from a plurality of received radio programs; and

FIG. 8 is a diagram showing the processing operation of the onboard phonographic equipment and is a flowchart showing processing in which a program is selected from a plurality of received radio programs.

### DESCRIPTION OF THE PREFERRED EMBODIMENTS

Some embodiments according to the present invention will be described in detail below with reference to the drawings. Although the following describes an example in which the present invention is applied to an onboard phonographic equipment that is mounted on a car, the present invention is not limited to this example but may be applied generally to a broadcast receiving apparatus that receives television or radio programs broadcast by broadcasting stations.

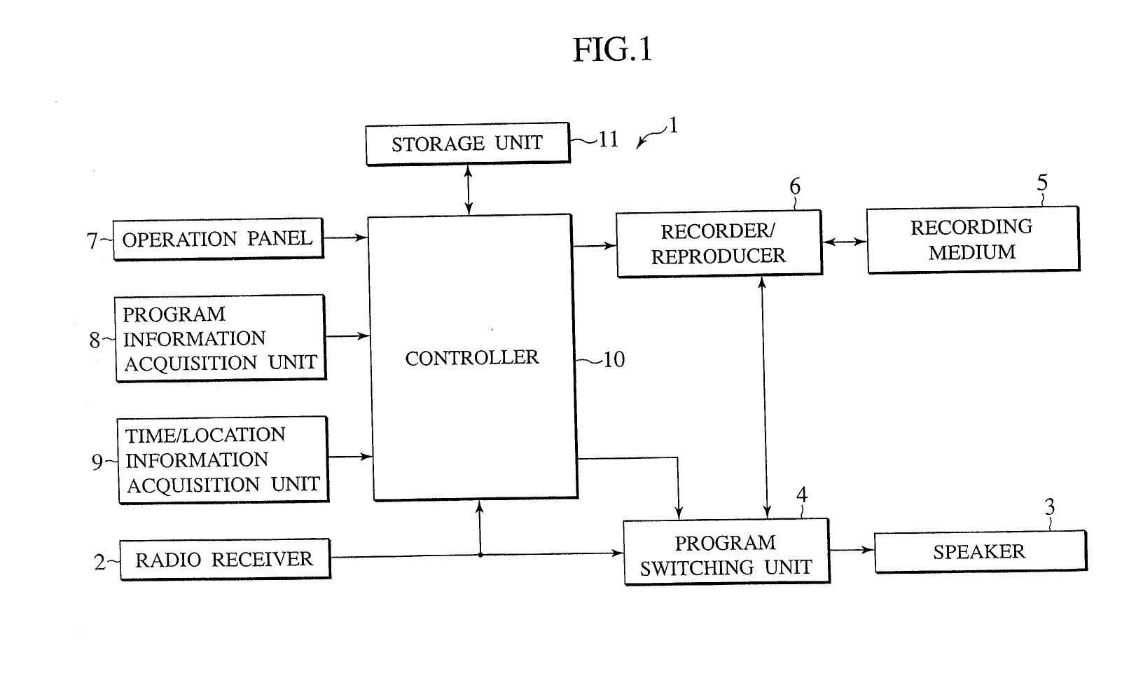

FIG. 1 shows an example of the configuration of an onboard phonographic equipment to which the present invention is applied. Onboard phonographic equipment 1 shown in FIG. 1 includes a radio receiver 2 that receives radio programs broadcast by broadcasting stations. A program switching unit 4 switches a program, one of a plurality of radio programs received by the radio receiver 2, for presentation to a car user through a speaker 3.

In addition, the onboard phonographic equipment 1 has a recorder/reproducer 6 that records radio programs received by the radio receiver 2 onto a recording medium 5 and that reproduces radio programs or other audio data from the recording medium 5. With this recorder/reproducer 6, the onboard phonographic equipment can reproduce radio programs and other audio data from the recording medium 5 to the car user through the speaker 3 as necessary.

The onboard phonographic equipment 1 further includes an operation panel 7 through which the car user enters operation instructions, a program information acquisition unit 8 that acquires information on radio programs broadcast by broadcasting stations, and a time/location information acquisition unit 9 that acquires information on the time and the location. Information acquired by those components is supplied to a controller 10 that controls the operation of the whole onboard phonographic equipment 1.

The operation panel 7 has several buttons such as a start switch button or a volume control button. When any of those operation buttons is pressed, a signal corresponding to the car user's operation is supplied to the controller 10.

The program information acquisition unit 8 acquires information on radio programs, broadcast by broadcasting stations, via a communication line or a memory card and supplies the acquired program information to the controller 10. Program information, which refers to various types of radio program information supplied by broadcasting stations, is used to create a program table such as an EPG (Electronic Program Guide).

When program information broadcast from broadcasting stations is superimposed on a radio program, the program information acquisition unit 8 is included in the radio receiver 2 described above. In this case, the program information acquisition unit 8 extracts program information from radio programs received by the radio receiver 2 and supplies the extracted information to the controller 10.

The time/location information acquisition unit 9, composed of a GPS (Global Positioning System) receiver and so on, receives signals from GPS satellites, calculates the current time (including year, month, day, and day of week) and the current location of the car on which the onboard phonographic equipment 1 is mounted based on the received signals, and supplies the calculated time or location information to the controller 10.

The controller 10 includes a CPU, a ROM, a RAM. The CPU executes a control program stored in the ROM with the RAM as a work area to control the operation of the whole onboard phonographic equipment 1. More specifically, upon receiving a signal from the operation panel 7 generated in response to the car user's operation, the controller 10 executes a control program corresponding to the operation to perform control operation requested by the car user.

The controller 10 also has a storage unit 11 connected. This storage unit contains databases in which various types of program selection information are stored, for example, program contents that were presented to the car user in the past and that satisfied predetermined conditions, time and location information when those programs were selected. The program contents refer to information identifying a particular program, such as a program name, a broadcasting station that broadcasts the program, a category to which the program belongs.

The controller 10 references the databases stored in the storage unit 11 to identify the past program-selection history to check what radio program was presented to the car user at what time and in what place. Based on the past program-selection history obtained from the databases, on the program information supplied from the program information acquisition unit 8, and on the time and location information supplied from the time/location information acquisition unit 9, the controller 10 examines a plurality of radio programs received by the radio receiver 2 to predict a radio program that would be requested at this moment by the car user of the car in which the onboard phonographic equipment 1 is mounted, and the controller 10 selects a program with the prediction result as the index. The controller 10 then causes either the program switching unit 4 to output the selected radio program through the speaker 3 or the recorder/reproducer 6 to record the selected radio program onto the recording medium 5.

In addition, after selecting a particular radio program from a plurality of radio programs received by the radio receiver 2, the controller 10 checks if the selected radio program satisfies predetermined conditions. More specifically, the controller 10 checks the past conditions for the selected radio program, for example, if the selected radio program was not switched within a predetermined period of time, or until the end of one unit is reached, or until the reception sensitivity is reduced. If it is found that the selected radio program satisfies the conditions, the controller 10 stores program selection information, such as the program contents and the time and location information on the program, into the storage unit 11 as databases.

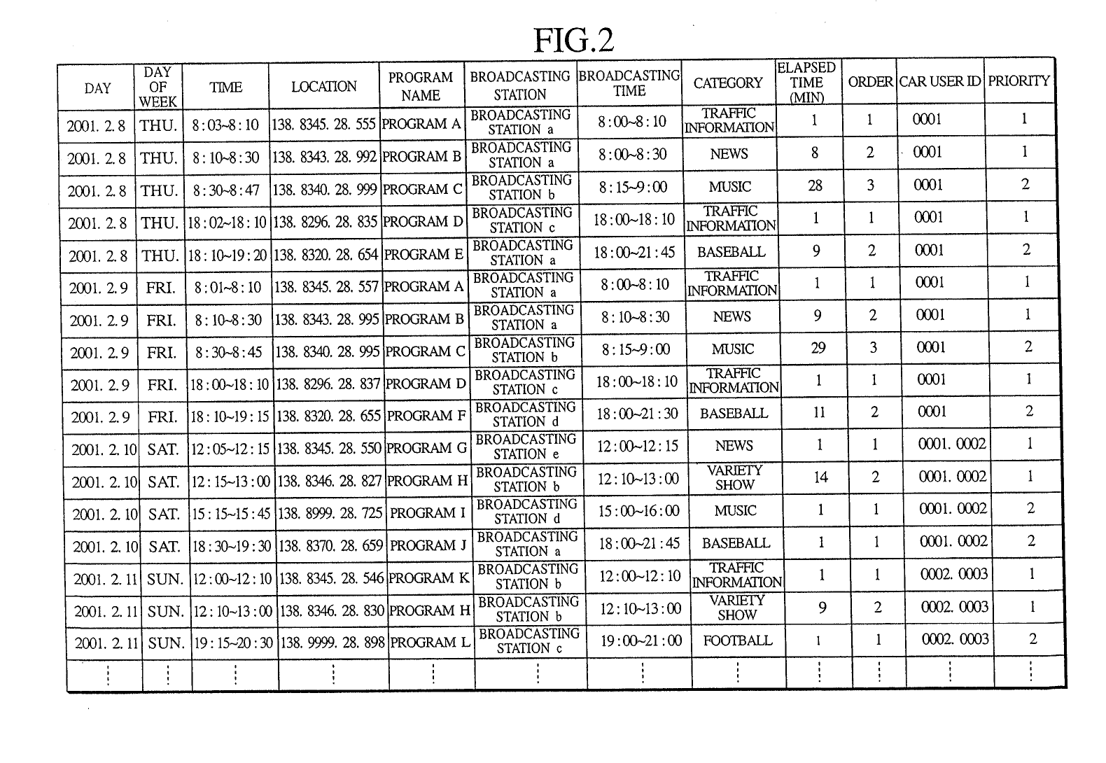

FIGS. 2-4 show an example of the format of the databases stored in the storage unit 11. Note that the databases stored in the storage unit 11 are not limited to the example shown in the figures but that the databases may be changed as necessary according to the requested performance.

In the example shown in FIGS. 2-4, the storage unit 11 stores, as past program-selection history databases, the day and the day of week on which a radio program was selected, the time at which the radio program was selected, the time at which the program was switched to the next program, and the location information indicating where the radio program was selected. The time/location information acquisition unit 9 supplies the current time and the current location information to the controller 10, which identifies the information and stores it in the storage unit 11.

The storage unit 11 also stores, as a database of past program-selection history, the name of a selected radio program, the broadcasting station that broadcasted the radio program, radio broadcasting time of the radio program, and the category to which the radio program belongs. The program information acquisition unit 8 supplies the program information to the controller 10, which identifies the information and stores it in the storage unit 11.

With the above-described information stored in the storage unit 11 as databases, the controller 10 may reference the databases when selecting a new radio program for the car user and may identify the contents of radio programs selected in the past and the time and location information on the selected programs.

The storage unit 11 also stores, as past program-selection history databases, the elapsed time from the moment the onboard phonographic equipment 1 was started to the moment a radio program was selected, the order in which the radio program was selected, the car user ID indicating the attribute of a car user, and the radio program priority.

The elapsed time from the moment the on board phonographic equipment 1 is started to the moment a radio program is selected is calculated by the controller 10 based on the time at which the onboard phonographic equipment 1 is started and the time at which the radio program is selected, and the resulting elapsed time is stored in the storage unit 11. The order in which the radio program is selected is determined by the controller 10 counting the number of times radio program selection has been made since the onboard phonographic equipment 1 is started, and the resulting count is stored in the storage unit 11. The car user ID is identified by the controller 10 when the car user enters his or her ID via the operation panel 7 when the onboard phonographic equipment 1 is started, and the entered ID is stored in the storage unit 11. The priority of a radio program is determined by the controller 10, for example, according to the ratio of actual listening time to the program broadcasting time, and the determined priority, that is, “1” for a high-priority radio program and “2” for a low-priority program, is stored in the storage unit 11. Although radio program priority evaluation is made at two levels in the example shown in FIG. 2, three or more priority levels maybe used. In addition, the priority may be determined not only by the ratio of actual listening time to the program broadcasting time. Other determination criteria, for example, whether or not the program was not switched to another program until the end of the program, may be used to determine the priority.

With the above-described information stored in the storage unit 11 as databases, the controller 10 may reference the database when selecting a new radio program for the car user and may identify the conditions and the priority of past radio program selection, as well as more detailed information, to reflect the information on program selection.

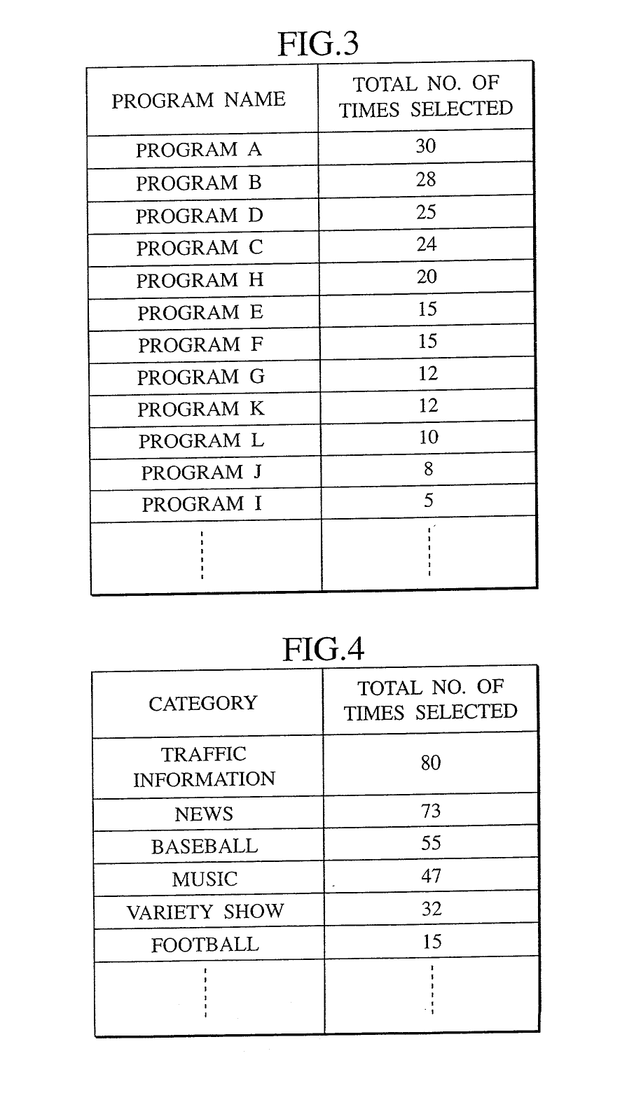

Also stored in the storage unit 11 is the information used to determine car user's taste, such as the total number of times a particular radio program was selected in the past such as the one shown in FIG. 3 and the total number of times each radio program category was selected in the past such as the one shown in FIG. 4. The controller 10 counts the total number of times a particular radio program was selected and the total number of times each program category was selected and stores the result in the storage unit 11. This information is updated each time information on a newly selected radio program is written.

With the above-described information stored in the storage unit 11 as databases for determining the car user's taste, the controller 10 may reference the database when selecting a new radio program for the car user and may identify the car user's taste for each program and car user's taste for each category to reflect the information on program selection.

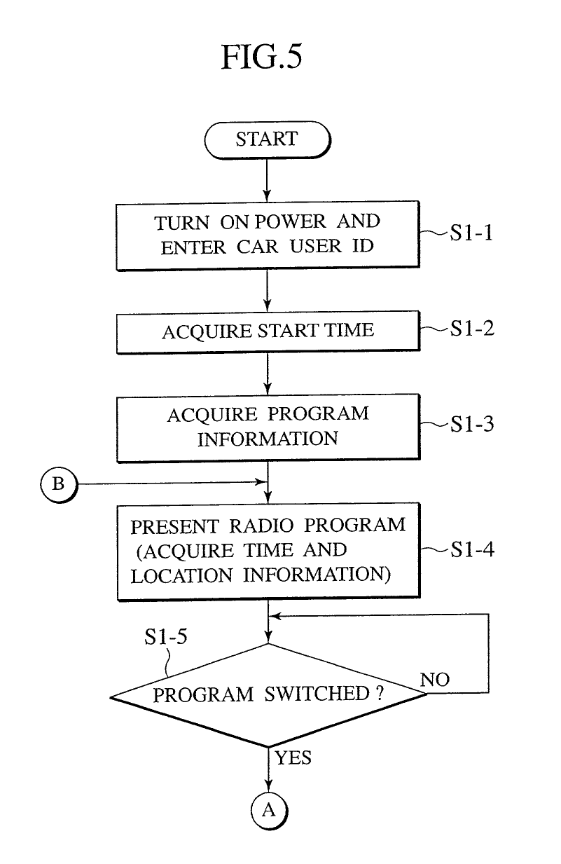

Now, referring to the flowcharts shown in FIGS. 5-8, the operation of the onboard phonographic equipment 1 to which the present invention is applied will be described. For convenience, the operation of the onboard phonographic equipment 1 is divided into two processing stages in the description below: a processing stage in which information used for program selection is stored as databases in the storage unit 11 and a processing stage in which a particular radio program is selected from a plurality of received radio programs In actual processing, these two processing stages are executed continuously as one sequence of processing.

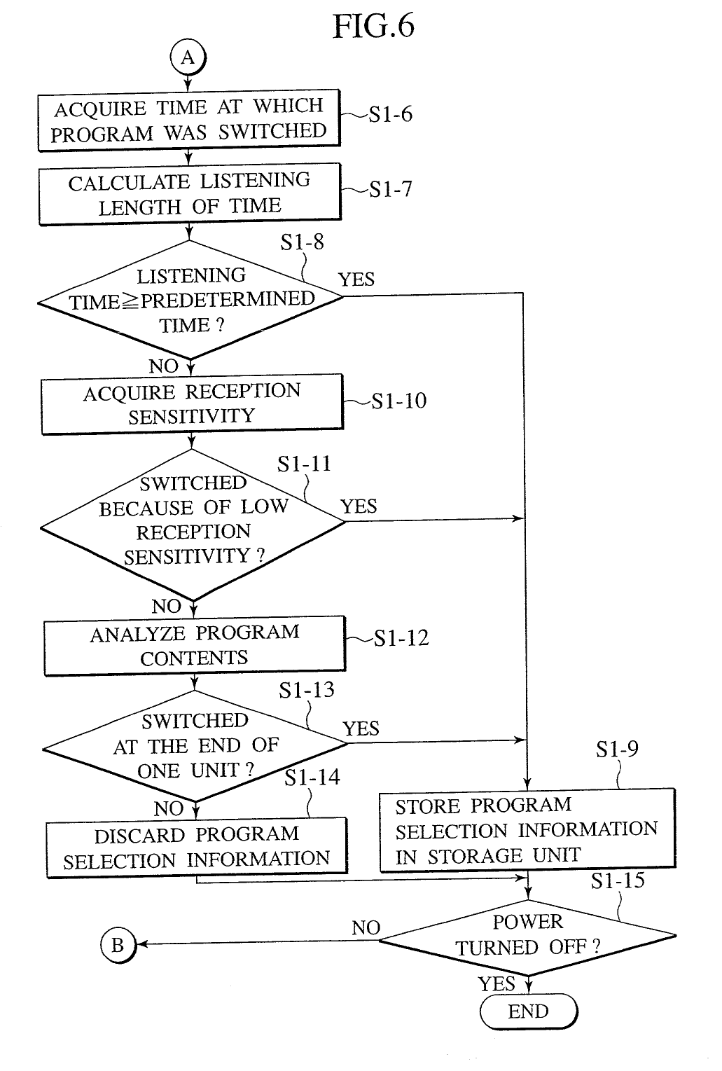

First, processing executed in the onboard phonographic equipment 1, to which the present invention applied, for storing program selection information as databases in the storage unit 11 will be described with reference to FIGS. 5 and 6.

In step S1-1, a car user performs operation to turn on power, starts the onboard phonographic equipment 1, and enters the car user ID. Then, in step S1-2, the time/location information acquisition unit 9 acquires the start time (including year, month, day, and day of week) of the onboard phonographic equipment 1 under control of the controller 10. In step S1-3, the program information acquisition unit 8 acquires program information on a radio program broadcast by a broadcasting station under control of controller 10. The start time of the onboard phonographic equipment 1 acquired by the time/location information acquisition unit 9 and the program information acquired by the program information acquisition unit 8 are stored temporarily in the RAM in the controller 10.

When a radio program is selected and presented to the car user in step S1-4, the time/location information acquisition unit 9 acquires, under control of the controller 10, information on the time and the location the radio program was selected and stores the acquired information temporarily in the RAM in the controller 10. If the radio program presented to the car user is switched to the next program in step S1-5, the time/location information acquisition unit 9 acquires the time, at which the radio program was switched to the next program, in step S1-6 under control of controller 10 and stores the acquired information temporarily in the RAM in the controller 10.

Next, in step S1-7, the controller 10 uses the time at which the radio program presented to the car user was selected and the time at which the program was switched to the next program to calculate the listening length of time of the program. In step S1-8, the controller 10 checks if the listening length of time of the radio program presented to the car user is equal to or longer than a predetermined length of time.

If the listening length of time of the radio program presented to the car user is found to be equal to or longer than the predetermined length of time in step S1-8, the radio program is determined to be desired by the car user. In step S1-9, the program selection information such as the information shown in FIGS. 2-4 is stored as databases in the storage unit 11 under control of the controller 10.

On the other hand, if the listening length of time of the radio program presented to the car user is found to be shorter than the predetermined length of time in step S1-8, the controller 10 acquires the reception sensitivity of the radio program, presented by the radio receiver 2 to the car user, in step S1-10. In step S1-11, the controller 10 checks if the radio program was switched because of low reception sensitivity.

If it is found that, in step S1-11, that the radio program presented to the car user was switched to the next program because of low reception sensitivity, the radio program is determined to be a program desired by the car user. In step S1-9, the information such as the one shown in FIGS. 2-4 is stored as databases in storage unit 11 under control of the controller 10.

On the other hand, if it is found in step S1-11 that the program presented to the car user was switched because of a condition other than low reception sensitivity, the contents of the radio program presented to the car user are analyzed in step S1-12 based on the program information stored temporarily in the RAM in the controller 10. Then, in step S1-13, the controller 10 checks if the radio program presented to the car user was switched to the next program at a point where the end of one unit of the program was reached.

If it is found that in step S1-13 that the radio program presented to the user was switched to the next program at a point where the end of one unit of the program was reached, the radio program is determined as a program desired by the car user. Then, in step S1-9, the program selection information such as the one shown in FIGS. 2-4 is stored as databases in the storage unit 11 under control of the controller 10.

On the other hand, if it is found that in step S1-13 that the radio program presented to the user was switched to the next program not at a point where the end of one unit of the program was reached, the radio program is determined as a program not desired by the car user. Then, in step S1-14, the program selection information is discarded.

After the program selection information is stored as databases in the storage unit 11 in step S1-19 or after the program selection information is discarded in step S1-14, the processing sequence for the onboard phonographic equipment 1 described above is ended if the onboard phonographic equipment 1 is turned off in step S1-15 when a turn-off operation request is entered or when the car engine is stopped. On the other hand, if the onboard phonographic equipment 1 is not turned off, control is passed back to step S1-4 and a sequence of steps following step S1-4 are repeated.

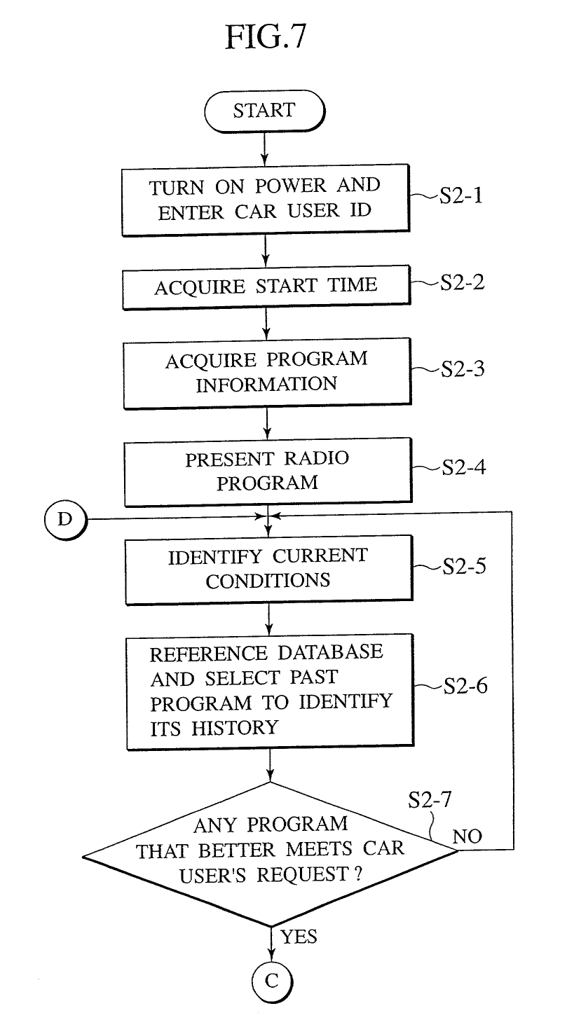

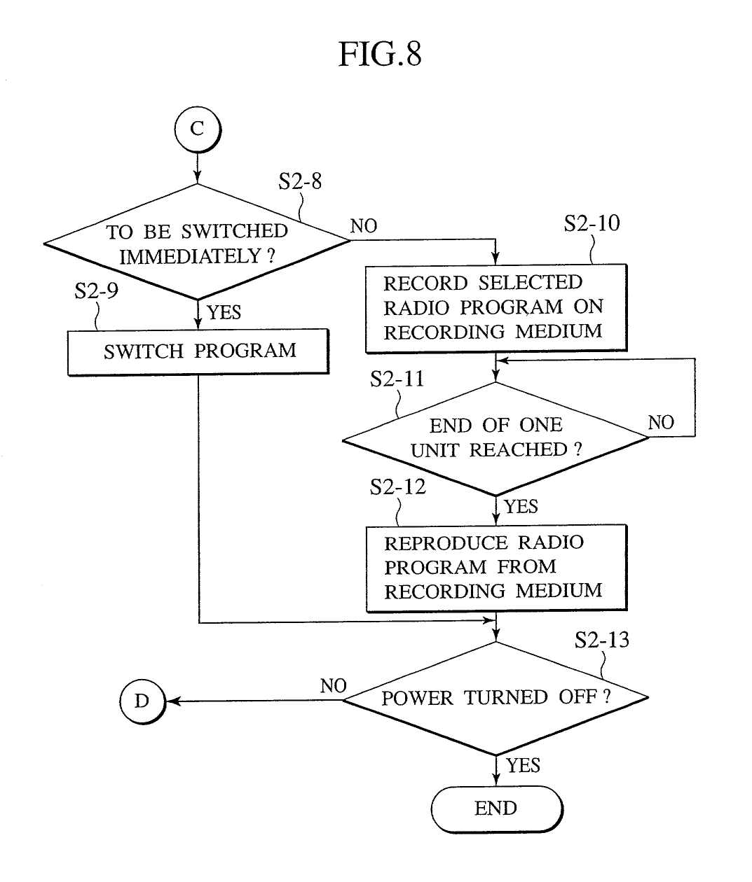

Next, processing executed in the onboard phonographic equipment 1, to which the present invention applied, for selecting a particular radio program from a plurality of received radio programs will be described with reference to FIGS. 7 and 8.

In step S2-1, the car user enters an operation request to turn on the onboard phonographic equipment 1 and enters the car user's ID. Next, in step S2-2, the time/location information acquisition unit 9 acquires the start time (including year, month, day, and day of week) of the onboard phonographic equipment 1 under control of the controller 10. In step S2-3, the program information acquisition unit 8 acquires, under control of the controller 10, program information on a radio program broadcast by a broadcasting station. The start time of the onboard phonographic equipment 1 acquired by the time/location information acquisition unit 9 and the program information acquired by the program information acquisition unit 8 are stored temporarily in the RAM of the controller 10.

In step S2-4, the radio receiver 2 receives a plurality of radio programs broadcast by broadcasting stations, and a radio program, such as the one on the channel selected at startup time, is presented to the car user. Then, in step S2-5, the time/location information acquisition unit 9 acquires the current time information and the current location information under control of the controller 10. At the same time, various types of information currently stored in the RAM of the controller 10 are read and given to the controller 10, which identifies various current conditions. These conditions include the current time (including year, month, day, and day of week), current location, car user's ID, and information on the radio program being broadcast.

In step S2-6, the controller 10 references the databases in the storage unit 11 to get information on the past program-selection history. In step S2-7, from the various current conditions and the past program-selection history, the controller 10 checks if there is a radio program that better meets the car user's request than the radio program being presented.

More specifically, the controller 10 extracts a best-matching radio program from a plurality of radio programs that may be received while considering the car user's taste and category for each program. The best-matching radio program is a program included in the past program-selection history and whose car user's ID and the program selection location exactly or nearly match the current user's ID and the current location, whose day of week matches the current day of week, and whose elapsed time and whose selection order since the startup of the onboard phonographic equipment 1 match the current elapsed time and the current selection order. The controller 10 checks whether or not the extracted radio program matches the radio program being presented to determine if there is a radio program that better meets the car user's request at this moment.

If, in step S2-7, it is determined that the radio program being presented is the program that best meets the car user's request at this moment, control is passed back to step S2-5 to repeat a sequence of processing that follows the step.

On the other hand, if it is determined in step S2-7 that there is a program that better meets the car user's request at this moment than the radio program being presented, the radio program is selected as a program to be presented to the car user. In step S2-8, the controller 10 checks if the radio program being presented should be switched to the newly-selected radio program immediately or not, for example, upon reception of user's operation request.

If it is determined, in step S2-8, that the radio program being presented should be switched to the newly-selected radio program immediately, the program switching unit 4 switches the program under control of the controller 10 in step S2-9 and the newly-selected radio program is output from the speaker 3 for presentation to the car user.

On the other hand, if it is determined in step S2-8 that the program should not be switched immediately, the recorder/reproducer 6 performs recording in step S2-10 under control of controller 10 to record the newly selected radio program on the recording medium 5. In step S2-11, the controller 10 finds a well-timed reproduction start time, for example, when the radio program currently presented is finished or the onboard phonographic equipment 1 is restarted. In step S2-12, the recorder/reproducer 6 starts reproduction at the well-timed start time and outputs the radio program from the recording medium 5 via the speaker 3 for presentation to the car user.

As described above, the onboard phonographic equipment 1 to which the present invention is applied causes the program switching unit 4 to switch the program immediately after startup of the equipment or at the end of the program, enabling the program to be switched without making the user feel an interruption.

In addition, if the program is not switched immediately after startup, the recorder/reproducer 6 records the selected program on the recording medium 5 to allow it to be presented to the user whenever the program is required.

If, after the newly-selected radio program is presented to the car user in step S2-9 or the radio program is reproduced from the recording medium 5 for presentation to the car user in step S2-12, the onboard phonographic equipment 1 is turned off in step S2-13 when a turn-off operation request is entered or when the car engine is stopped, the above-described processing sequence on the onboard phonographic equipment 1 is ended. On the other hand, if the onboard phonographic equipment 1 is not turned off, control is passed back to step S2-5 and a sequence of processing that follows step S2-5 are repeated.

As described above, when the onboard phonographic equipment 1 to which the present invention is applied selects a new radio program to be presented to the car user, the controller 10 predicts a radio program, which will be requested by the car user at this moment, from a plurality of radio programs received by the radio receiver 2 based on the databases in the storage unit 11 containing information on the past program selection history, the program table created based on the program information supplied from the program information acquisition unit 8, and the current time information and current location information supplied from the time/location information acquisition unit 9. This means that the equipment eliminates the need for the car user to do cumbersome tasks such as keyword information entry but selects a program automatically considering car user's taste according to the time and the place. Therefore, the broadcast receiving apparatus, even if mounted in a vehicle such as a car, can present a program that best meets the user's request according to the time and the place.

In addition, when the onboard phonographic equipment 1 has selected a new radio program for presentation to the car user, the controller 10 causes either the program switching unit 4 to output the selected radio program from the speaker 3 or the recorder/reproducer 6 to record the selected radio program on the recording medium 5. This configuration presents a program requested by the user with no need for the car user to switch the program during driving and, at the same time, prevents the program switching operation from affecting the driving operation.

It should be understood that many modifications and adaptations of the invention will become apparent to those skilled in the art and it is intended to encompass such obvious modifications and changes in the scope of the claims appended hereto.

The entire contents of Japanese Patent Application No. 2001-55295 , filed on Feb. 28, 2001 are hereby incorporated by reference.

What is claimed is:

1. A broadcast receiving apparatus that receives a plurality of programs broadcast by broadcasting stations and selects any one of the plurality of programs for presentation to a user, said broadcast receiving apparatus comprising:
a program information acquisition unit configured to acquire program information on programs broadcast by the broadcasting stations;
a time/location information acquisition unit configured to acquire at least one of current time information and current location information;
a storage unit configured to store information; and
a controller configured to control an operation of said broadcast receiving apparatus,
wherein said controller stores, into said storage unit as a database, contents of a program selected in the past and satisfying predetermined conditions and at least one of program selection time information and location information and, at the same time, predicts one of said plurality of received programs that will be requested by the user at this moment, based on the database stored in said storage unit, the program information acquired by said program information acquisition unit, and at least one of the current time information and the current location information acquired by said time/location information acquisition unit, for use as a program selection index.

2. The broadcast receiving apparatus according to claim 1, further comprising a program switching unit configured to switch a program to be presented to the user in response to a program selection by said controller.

3. The broadcast receiving apparatus according to claim 2, wherein said program switching unit switches the program to be presented to the user immediately after said broadcast receiving apparatus is started or when the program is ended.

4. The broadcast receiving apparatus according to claim 2, further comprising a program recording unit configured to record a program selected by said controller onto a recording medium.

5. The broadcast receiving apparatus according to claim 4, wherein said program switching unit switches the program to be presented to the user to the program recorded on the recording medium by said program recording unit immediately after said broadcast receiving apparatus is started or when the program is ended.

6. The broadcast receiving apparatus according to claim 1, wherein said controller stores information on a program and circumstances when the program was selected into said storage unit as a database, said program being selected in the past, said program being a program that was not switched within a predetermined time, a program that was not switched until an end of one unit was reached, or a program that was not switched until radio reception sensitivity declined.

7. The broadcast receiving apparatus according to claim 1, wherein said controller stores into said storage unit a total number of selection times of the program satisfying the predetermined conditions and, at the same time, judges a user's taste based on the total number of selection times stored in said storage unit, and predicts one of the plurality of received programs that will be requested by the user at this moment while taking the user's taste into consideration, for use as a program selection index.

8. The broadcast receiving apparatus according to claim 1, wherein said controller stores into said storage unit a total number of selection times of a category of the program satisfying the predetermined conditions and, at the same time, judges a user's taste according to the category based on the total number of selection times of the category stored in said storage unit, and predicts one of the plurality of received programs that will be requested by the user at this moment while taking the user's taste according to the category into consideration, for use as a program selection index.

9. The broadcast receiving apparatus according to claim 1, wherein said controller stores attribute information of the user into said storage unit when the program satisfying the predetermined conditions is selected and, at the same time, and predicts one of the plurality of received programs that will be requested by the user at this moment while taking the attribute information of the user into consideration for use as a program selection index.

10. The broadcast receiving apparatus according to claim 1, wherein said controller stores, into said storage unit as circumstances when the program satisfying the predetermined conditions was selected, an elapsed time from a moment said broadcast receiving apparatus was started to a moment said program was selected and an order in which said program was selected when the program satisfying the predetermined conditions was selected and, at the same time, and predicts one of the plurality of received programs that will be requested by the user at this moment while taking the elapsed time and the order into consideration, for use as a program selection index.

11. A broadcast receiving apparatus that receives a plurality of programs broadcast by broadcasting stations and selects any one of the plurality of programs for presentation to a user, said broadcast receiving apparatus comprising:
program information acquisition means for acquiring program information on programs broadcast by the broadcasting stations;
time/location information acquisition means for acquiring at least one of current time information and current location information;
storage means for storing information; and
control means for controlling an operation of said broadcast receiving apparatus,
wherein said control means stores, into said storage means as a database, contents of a program selected in the past and satisfying predetermined conditions and at least one of program selection time information and location information and, at the same time, predicts one of said plurality of received programs that will be requested by the user at this moment, based on the database stored in said storage means, the program information acquired by said program information acquisition means, and at least one of the current time information and the current location information acquired by said time/location information acquisition means, for use as a program selection index.

12. A received program selection method, comprising:
acquiring program information on programs broadcast by broadcasting stations;
acquiring at least one of current time information and current location information;
storing, into a storage unit as a database, contents of a program selected in the past and satisfying predetermined conditions and at least one of program selection time information and location information; and
predicting one of a plurality of programs, received from broadcasting stations, that will be requested by the user at this moment, based on the database stored in said storage unit, the acquired program information, and at least one of the acquired current time information and the current location information, for use as a program selection index.
